(19) United States
(12) Patent Application Publication
(10) Pub. No.: US 2018/0291662 A1
(43) Pub. Date: Oct. 11, 2018

(54) A PANEL AND A PANEL SYSTEM

(71) Applicant: LUMON INVEST OY, Kouvola (FI)

(72) Inventor: Esa HILLIAHO, Valkeala (FI)

(73) Assignee: LUMON INVEST OY, Kouvola (FI)

(21) Appl. No.: 15/764,862

(22) PCT Filed: Nov. 3, 2016
(86) PCT No.: PCT/FI2016/050775

§ 371 Date: Mar. 29, 2018

(30) Foreign Application Priority Data
Nov. 10, 2015 (FI) 20155827

(51) Int. Cl. E05D 15/06; E05D 15/58; E06B 3/50

(52) U.S. Cl. CPC E05D 15/0604; E05D 15/58; E05Y 2900/148; E05Y 2201/614; E05Y 2900/132; E06B 3/5072

(57) ABSTRACT

The panel of the panel system is movable and is intended to be positioned and connected between an essentially parallel lower guide and upper guide of the system in order to move the panel on the lower guide. The panel, for example, its lath, includes at least one claw configured to grip the lower guide, which is connected to the panel so the claw is able to move in the vertical direction when the panel is vertical. When pulled away from the panel, the claw may be attached to the lower guide. The claw tends to retract by itself towards the panel, away from the lower guide, which may include a rail to which the claw is attached and on which the panel may rest as it moves along the lower guide. As an extension of the rail may be an auxiliary rail, including, for example, a guide surface.

### OBJECT OF THE SOLUTION

The object of the solution is a panel system. The object of the solution further comprises a panel of the a panel system. The object of the solution further comprises a lower guide of the panel system.

### BACKGROUND OF THE PRESENT SOLUTION

Different types of panel systems may be incorporated in buildings, for example, in conjunction with the balcony or terrace of a building. These are often panels made of glass or a similar material, several panels being positioned most preferably in succession in a panel system. Panel systems may also be provided inside buildings, for example as walls.

A panel system typically comprises an upper guide and a lower guide, which may be rails guiding the travelling of the panel and inside or on top of which are one or more hinge elements and/or a control element fixed to the panel. The hinge element and/or control element controls the travelling of the panel, or the panel is suspended on the upper guide by means of them, or the panel rests through them on the lower guide which supports the panel. The hinge element or control element is either stationary or movable along the upper or lower guide with the panel. The panel may be movable along the upper and lower guides by means of the said hinge element or control element. Moving typically takes place manually.

The upper and lower guides are usually horizontal and fixed, for example, to the structures of the building. The lower guide may be positioned on floor level or higher, for example, on a railing. The panel may be opened and closed by using one or more hinge elements, by means of which the panel turns around a vertical rotation axis. The said openable panel may in addition comprise one or more control elements, by means of which the panel remains closed, and which is allowed to come out of the upper or lower guide to enable the opening of the panel. The upper or lower guide may comprise an opening through which the control element passes, or the control element may be lifted out, for example from the lower profile.

The hinge element may be configured to lock with the hinge element of the adjacent panel, the upper guide or the lower guide when the panels are open and adjacent to one another. Two or more panels may be open and adjacent to one another in a stack, whereupon a free opening is formed, for example, for airing or access.

A known panel system is disclosed in publication WO-2014068178-A1.

In an openable panel of the panel system, a control element on its opening edge, which element is by the lower guide, must be lifted up manually or there is no control element in the said panel. This means that opening the panel also requires lifting the control element, or in the latter case the panel will be unstable and susceptible, for example, to the effect of wind or deformation due to the lacking control element. The lower guide may also support the openable panel and thus the distancing or lifting off of the panel from the lower guide should be prevented.

### A BRIEF SUMMARY OF THE SOLUTION PRESENTED

The panel system according to the solution presented is disclosed in claim 1. A panel of the panel system according to the solution presented is disclosed in claim 16. A lower guide of the panel system according to the solution presented is disclosed in claim 19.

The panel of the panel system according to the solution is movable. The panel is intended to be positioned and connected between the essentially parallel lower guide and upper guide of the panel system in order to move the panel on the lower guide. The panel, for example, its lath, comprises at least one claw configured to grip the lower guide. The claw is connected to the panel in such a way that the claw is able to move in the vertical direction when the panel is vertical. When pulled away from the panel, the claw may grip the lower guide. The claw will tend to retract by itself towards the panel, away from the lower guide.

The claw prevents the panel from rising off the lower guide or from on top of it, alternatively it restricts the rising of the panel upwards. The claw tends to move upwards by itself and automatically and thus no manual control is required. When retracted, the claw may also be configured so as to settle higher than the lower guide and it will thus not prevent the opening of the panel and, if necessary, the claw will be able to travel over the lower guide. The claw may also prevent the panel from turning or swaying, for example, due to the effect of wind.

The panel system according to the solution comprises the panel described above and in addition a lower guide and an upper guide, which are essentially parallel and between which the panel is positioned and to which the panel is connected for moving. The lower guide comprises a rail on which the panel is supported when moving along the lower guide. On at least one side of the rail is a flange which is fixed to the essentially vertical web of the rail. The claw is configured to remain under the flange when the panel moves, when the claw is pulled away from the panel. The claw prevents the panel from rising up or falling off the rail.

The rail described above provides a structure which the claw is able to grip.

As an extension of the flange may be a guide surface which is directed downwards and inclined with respect to the horizontal direction and the flange. According to an example, when the panel moves in a first direction, the guide surface is configured to force the claw to move away from the panel and under the flange. According to another example, when the panel moves in the opposite, second direction, the guide surface is configured to allow the claw to move towards the panel and out from under the flange.

In the lower guide of the panel system according to the solution, on which the panel of the panel system is intended to rest when moving along the lower guide, is a rail on which the panel may rest when moving along the lower guide. As an extension of the rail is auxiliary rail on which the panel may also rest when moving along the lower guide.

According to an example, the guide surface described above is located in the auxiliary rail.

By means of the auxiliary rail, a part of the lower guide and its rail can be replaced with a part in which can be formed shapes and structures, such as reductions, which are difficult or expensive to make in the lower guide. The lower guide may thus be an extruded continuous part to which other shapes can be added by means of an auxiliary rail. To the auxiliary rail may also be connected or fixed other parts, such as a support part or a support surface. The positioning of the different parts with respect to one another and the lower guide is thus facilitated if the parts are already in the same part.

### DESCRIPTION OF THE DRAWINGS

The solution presented is described in greater detail in the following, with reference to the accompanying drawings.

FIG. 1 shows a front view of a panel system to which the solution presented may be applied,

FIG. 2 shows a side view of an example of the panel system of FIG. 1, a lower guide and a panel, to which the solution presented may be applied, and when the panel is moving to a predetermined point and away from it.

FIG. 3 shows an example of the panel system of FIG. 1, a lower guide, to which the solution presented may be applied,

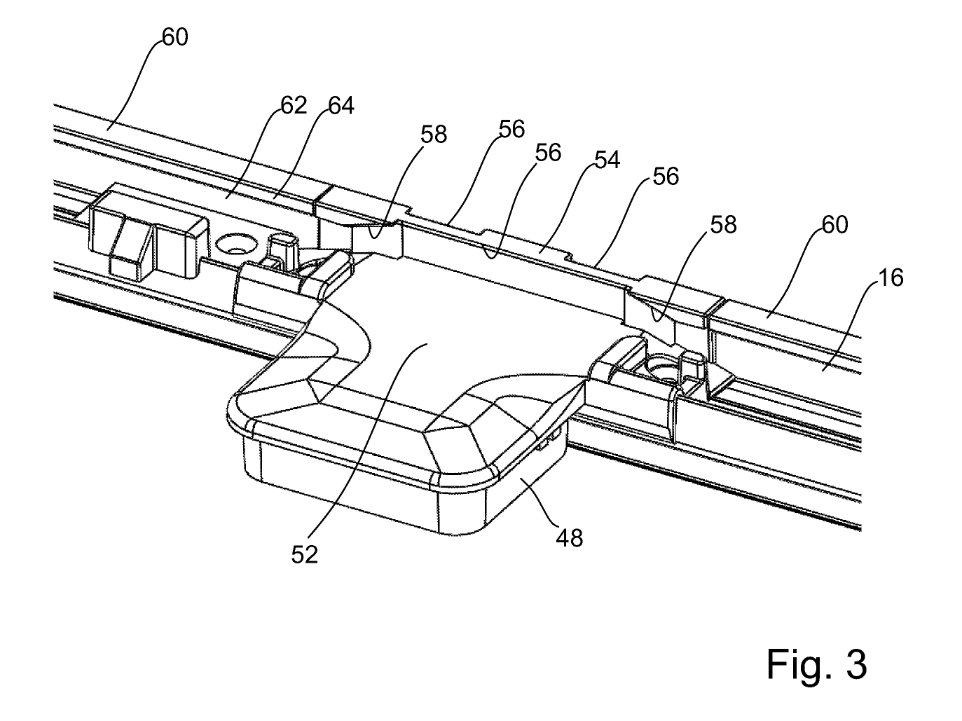

FIG. 4 shows the panel and the lower guide of FIG. 2 with the panel moved to a predetermined point for opening.

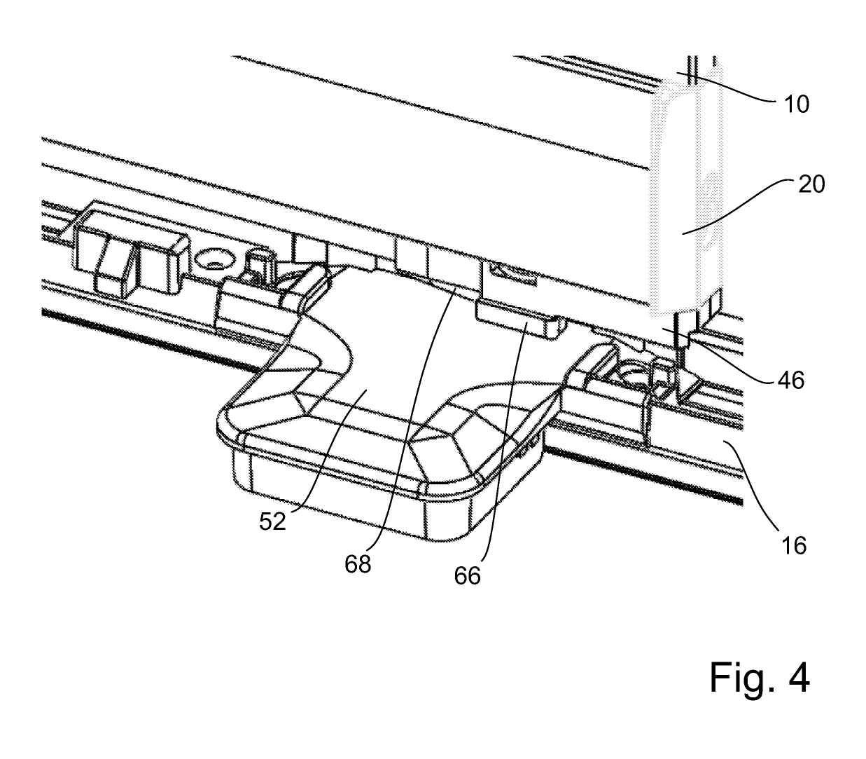

FIG. 5 shows the panel and a lower guide of FIG. 2 when the panel is opening.

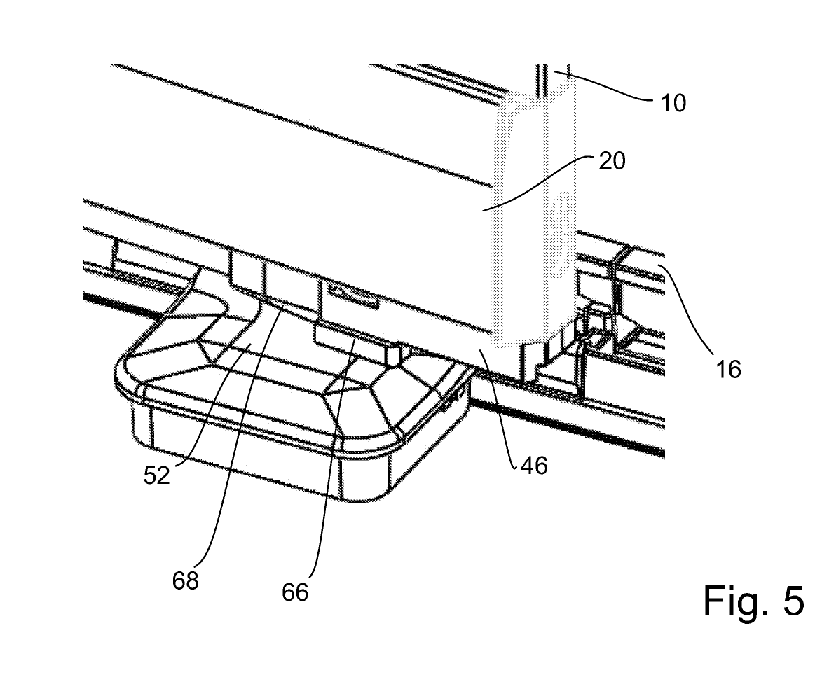

### DETAILED DESCRIPTION OF THE SOLUTION

In the Figures, the same or corresponding parts are marked with the same reference number.

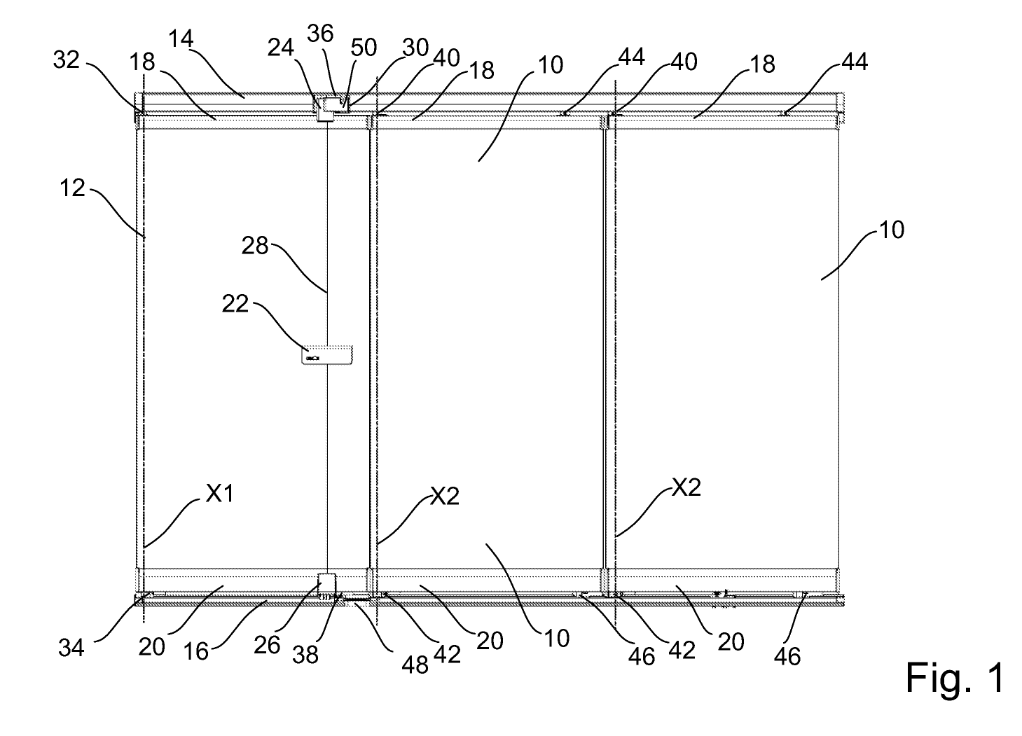

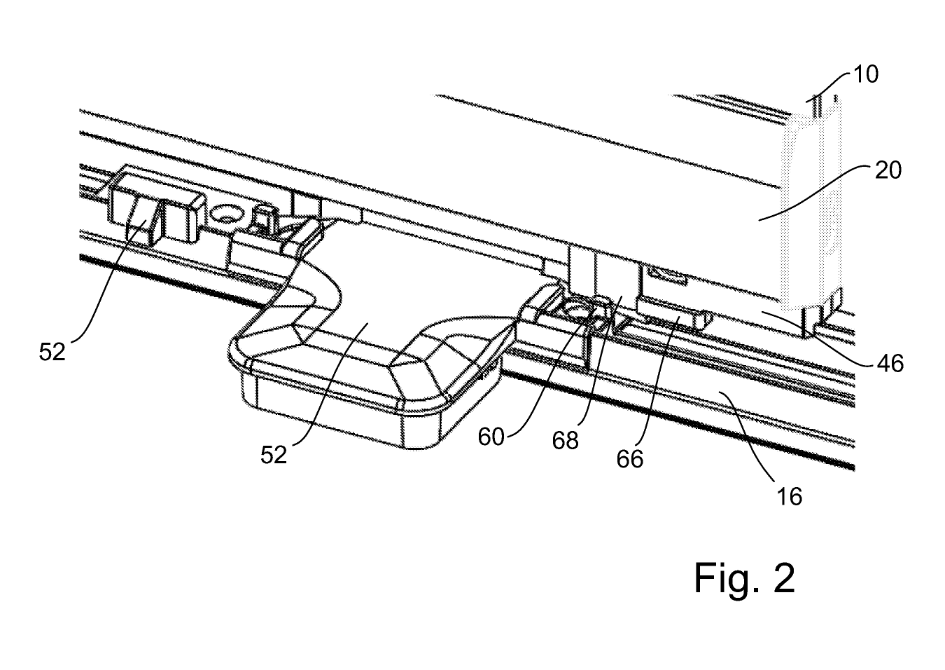

FIGS. 1 and 2 show an example of a panel system to which the solutions presented may be applied.

The panel system may comprise at least one moving panel 10, a lower guide 16, an upper guide 14, a hinge element 40 fixed to the upper edge of each panel 10 and a hinge element 42 fixed to the lower edge of each panel 10.

According to one example, the panel system may further comprise at least one stationary panel 12 which does not move along the lower and upper guides 14, 16, a hinge element 32 fixed to the upper edge of each panel 12 and a hinge element 34 fixed to the lower edge of each panel 12.

The panel 12 may be opened in such a way that it turns around a vertical rotation axis X1. The rotation axis X1 is perpendicular to the longitudinal directions of the lower and upper guides 14, 16. The said rotation axis X1 is furthermore located in the vicinity of one vertical edge of the panel 12.

When closed, the panels 10, 12 are most preferably parallel and positioned in succession in such a way that they form a wall or window or an access opening. The lower guide 16 and the upper guide 14, which are parallel, are located at a distance from one another and positioned vertically on top of one another. The panels 10, 12 are located between the lower guide 16 and the upper guide 14 in such a way that the panels 10, 12 are vertical. The two opposite upright edges of the panel 10, 12 are vertical and the upper and lower edges of the panel 10,12 are horizontal. The lower guide 16 may attach to a railing or a suitable surface, for example the floor. The lower guide 16 may be at least partly embedded in a railing or floor. The upper guide 14 may attach, for example, to a ceiling or other suitable structure.

The hinge element 32 is located inside the upper guide 14 and allows the panel 12 to be opened. Rotation axis X1 passes through the hinge element 32. The hinge element 32 may be locked to the upper guide 14.

The hinge element 34 is located inside the lower guide 16, or on top of it, and allows the panel 12 to be opened. Rotation axis X1 also passes through the hinge element 34. The hinge element 34 may be locked to the lower guide 16.

Hinge element 32 and/or hinge element 34 may comprise a shaft journal on which the panel 12 turns. Hinge element 32 and/or hinge element 34 may be configured to lock with the hinge element 40, 42, upper guide 14 or lower guide 16 of the adjacent panel 10 when panel 10 is opened and the panel 12 is open.

According to one example and FIG. 1, on the upper edge of the panel 10, 12 may be fixed a lath 18 to which the hinge element 32, 40 may be fixed, for example, with screws or nuts. On the lower edge of the panel 10, 12 may be fixed a lath 20 to which the hinge element 34, 42 may be fixed, for example, with screws or nuts. The lath 19, 20 forms a part of the panel 10, 12, for example, the lower edge or upper edge of the panel 10,12.

According to one example and FIG. 1, on the upper edge of the panel 12 may be fixed a lock part 24 which attaches to the upper guide 14 and is at a distance from the hinge element 32. The lock part 24 can be opened and detached from the upper guide 14 for opening the panel 12. The lock part 24 is controlled, for example, by means of a pulling cable, chain or wire or the like 28. To the panel 12 may be fixed a handle part 22. The handle part 22 may control the lock part 24, other locking part or other parts of the panel system, for example, by means of the power conveyed by a cable, chain, wire or the like 28. Moving the handle part 22 opens the lock part 24. The handle part 22 is, for example a turning or rotating handle or knob fixed to the centre part of the panel 12 or alternatively on the lower edge of the panel 12, for example on a lath 20. According to an example, the handle part 22 is a part of the above-mentioned locking part or other above-mentioned part of the panel system.

According to an example and FIG. 1, on the lower edge of the panel 12 may be fixed a lock part 26 which attaches to the lower guide 16 and is at a distance from the hinge element 34. The lock part 26 is controlled, for example, by means of a handle part 22 and a pulling cable, chain, wire or the like 28.

The moving panel 10 may be moved along the lower and upper guides 14, 16. The panel 10 may, in addition, be opened in such a way that it turns around a vertical rotation axis X2. For opening, the panel 10 may be moved to a predetermined point where, for example, rotation axes X1 and X2, or two rotation axes X2, are close to one another. Rotation axis X2 is perpendicular to the longitudinal directions of the lower and upper guides 14, 16. The said rotation axis X2 is furthermore located in the vicinity of one vertical edge of the panel 10.

The hinge element 40 is located inside the upper guide 14 and allows the panel 10 to be opened. Rotation axis X2 passes through the hinge element 40. The hinge element 40 is able to move along the upper guide 14.

The hinge element 42 is located inside the lower guide 16, or on top of it, and allows the panel 10 to be opened. Rotation axis X2 also passes through the hinge element 42. The hinge element 42 is able to move along the lower guide 16, for example by means of a roller or wheel.

Hinge element 40 and/or hinge element 42 may comprise a shaft journal on which the panel 10 turns. Hinge element 40 and/or hinge element 42 may comprise a locking part, by means of which the hinge element 40, 42 locks with the upper guide 14, the lower guide 16 or the hinge element 40, 42 of the adjacent panel 10 when the adjacent panel 10 is opened and panel 10 is open.

The panel 10 may in addition comprise a control element 44 attached on the upper edge of the panel 10, for example, to a lath 18. The control element 44 is located inside the upper guide 14, able to move along the upper guide 14, and at a distance from the hinge element 40. While inside the upper guide 14, the control element 44 keeps the panel 10 closed. The upper guide 14 may comprise an opening 30 allowing the control element 44 to exit from the upper guide 14 and to detach from the upper guide 14 in order to make the opening of the panel 10 possible. The opening 30 may be situated under the lock part 24. By the opening 30 may be located an upper control unit 50 which supports the control element 44 exiting from and returning to the upper guide 14.

The panel 10 may comprise a control element 46 fixed to the lower edge of the panel 10, for example to a lath 20. The control element 46 is located inside the lower guide 16, or on top of it, so as to allow the control element 46 to move along the lower guide 16. The control element 46 is at a distance from the hinge element 42. The control element 46 moves along the lower guide 16, for example, by means of a roller or wheel. The control element 46 is allowed to detach or distance itself from the lower guide 16, thus enabling the opening of the panel 10.

The lower guide 16 may comprise a support part 48. A support part 48 fixed in place adjacent to the lower guide 16 supports an opening panel 10 which has been moved to a predetermined point for opening the panel 10. The support part 48 is then at a distance from the hinge element 42 of the opening panel 10.

The panel 10 may comprise a support 66 fixed to the lower edge of the panel, for example to a lath 20. The opening panel 10 is supported by means of the support 66. The support 66 is at a distance from the hinge element 42. Through the support 66, the panel 10 rests, for example, on the lower guide 16 or the part fixed to it which forms a part of the lower guide 16.

The support 66 may be fixed to the panel 10 or under the lath 20. The support 66 may be a part of the control element 46. The support 66 is allowed to detach or distance itself from the lower guide 16 when the panel 10 is opened. The support 66 is fixed to the panel 10 or lath 30 rigidly or immovably, or the support 66 may be locked into a position where it is immobile.

The support part 48 may comprise a support plane 52 which extends sideways from the lower guide 16 and on top of which the panel 10 slides when the panel 10 is opened sideways. The panel 10 rests on the support plane 52, for example, through the support 66. The support part 48 or support plane 52 supports the panel 10 while the panel 10 is being opened.

Once the panel 10 has opened to the predetermined extent, which depends on the length of the support part 48 or support plane 52, the panel 10 or the support 66 moves away from on top of the support part 48 or support plane 52 when the panel 10 is opened further. By means of the support part 48 or support plane 52 the falling of the panel 10 is prevented and it is ensured, for example, that the hinge element 40 locks to the upper guide 14 or to the hinge element 40 of the adjacent panel 10.

The panel 10 or the support 66 moves on top of the support part 48 or support plane 52 both when the panel 10 is being closed and when the panel 10 is being moved in the direction of the lower guide 16, when the panel 10 is moved to a predetermined point for opening the panel 10.

The top surface of the support part 48 or support plane 52 may be inclined. One or more edges of the support part 48 or support plane 52 may have an inclined surface which guides the panel 10 or support 66 onto the support part 48 or support plane 52. The top surface 48 of the support part 48 or the support plane 52 is at a height at which the panel 10 rises when the panel 10 or support 66 moves onto the support part 48 or support plane 52, or the panel 10 remains at the same height irrespective of whether the panel 10 or support 66 is on top of the support part 48 or support plane 52 or off it.

According to an example, the support 66 extends vertically lower than the panel 10 and the lath 20. The support plane 52 also extends lower than the panel 10 and the lath 20. The support 66 then slides along the support plane 52 and the panel 10 and lath 20 are able to pass over the support plane 52 when the panel 10 slides past the support plane 52.

According to an example, the lower guide 16 comprises a rail 60 on which the panel 10 rests when it moves along the lower guide 16. The hinge element 42 and the guide element 46 rest on the rail 60 when they move along the lower guide 16.

According to an example, the support 66 extends vertically lower than the upper surface of the rail 60. The structure of the control element 46 or the support 66 may settle against one side of the lower guide 16 or rail 60, or close to it, and prevent a closing or closed panel 10 from swaying or moving over the lower guide 16 or the rail 60 to the opposite side of the lower guide 16 with respect to the opening direction.

According to an example, when the rail 60 is in its position of use, for example, horizontal, on one side or two opposite sides of the rail 60 is a flange 64 which is fixed to the essentially vertical web 62 of the rail 60. The rail 60, including the flange 64, and the web 62, is elongated and the flange 64 extends in the longitudinal direction of the rail 60. The flange 64 may be located on the upper edge of the web 62 or lower. The flange 64 extends sideways from the web 62 and has a downwards directed lower surface.

According to an example, the flange 64 and the rail 60 have a joint upper surface. The lower surface of the flange 64 is located vertically lower than the upper surface of the rail 60. The hinge element 42 and the control element 46 may rest on the above-mentioned joint upper surface.

According to an example, a part of the rail 60 of the lower guide 16 is replaced with a separate part, a so-called auxiliary rail 54, on which the panel 10 or the hinge element 42 and the control element 46 may rest as it moves along the lower guide 16. The auxiliary rail 50 is an extension of the rail 60. According to an example, on at least one side or two opposite sides of the auxiliary rail 54 is a flange 64 which is fixed to the essentially vertical web 62 of the rail 54. The flange 64 extends sideways and has a lower surface. According to an example, the flange 64 and the auxiliary rail 54 have a joint upper surface. The lower surface of the flange 64 is located vertically lower than the upper surface of the auxiliary rail 54. The hinge element 42 and the control element 46 may rest on the above-mentioned joint upper surface.

A part of the rail 60 of the lower guide 16 at the support plane 53 is replaced with an auxiliary rail 54, in such a way that the upper surfaces of the rail 60 and auxiliary rail 54 are extensions of one another and at the same height. A hinge element 42 moving along the lower guide 16 is capable of moving from on top of the rail 60 onto the auxiliary rail 54, over the auxiliary rail 54 and further onto the rail 60. According to an example, depending on the positioning of the control element 46, the control element 46 moving along the lower guide 16 is also capable of moving from on top of the rail onto the auxiliary rail 54.

The lower guide 15 rail 60 has, for example, an opening in which the auxiliary rail 54 may be positioned. According to an example, the support part 48 and the auxiliary rail 54 are fixed to one another or the auxiliary rail 54 is a seamless part of the support part 48.

According to an example, the flange 64 on one side of the rail 60 or auxiliary rail 64 is located on the same side of the rail 60 or auxiliary rail 54 as the support part 48 or support surface 52.

On one side or two opposite sides of the rail 60 or auxiliary rail 54 is a flange 64 which may be tapered over at least one predetermined length. The tapered section 56 of the rail 60 or auxiliary rail 54 is narrower than the section of the flange 64, rail 60 or auxiliary rail 54 preceding the beginning and/or end of the tapered section 56. According to an example, the tapered section 56 is located entirely in the auxiliary rail 54 and does not, therefore, extend to the rail 60.

According to an example, the flange 64 of the rail 60 or auxiliary rail 54 located on the same side of the rail 60 or auxiliary rail 54 as the support part 48 or support surface 52 is tapered.

As an extension of the flange 64 of the rail 60 or auxiliary rail 54 may be a guide surface 58 which is directed downwards and is inclined with respect to the horizontal direction and the flange 64, for example, with respect to the lower surface of the flange 64.

The guide surface 58 rises and ends at the end of the flange 65, to the beginning of the tapered section 56 or to the end of the tapered section 56. One guide surface 58 may be located at the beginning of the tapered section 56 and another guide surface 58 at the end of the tapered section 56. There may be guide surfaces 58 on both sides of the rail 60 or auxiliary rail 54 in conjunction with the end of the flange 65 or the tapered section 56.

According to an example, one or more guide surfaces 58 are located entirely in the auxiliary rail 54 and do not, therefore, extend to the rail 60.

The panel 16 or lath 20 may further comprise a claw 68 which is configured to grip the lower guide 16, the rail 60 or the auxiliary rail 54. The claw 68 prevents a closed panel 10 from rising off the lower guide 16, the rail 60 or the auxiliary rail 54, or prevents the panel 10 from rising upwards.

The claw 68 is connected to the panel 10 or lath 20 movably in such a way that the claw 68 is able to reciprocate, that is, move away from the panel 10 or lath 20 and towards the panel 10 or lath 12. The claw 68 moves essentially in the vertical direction when the panel 10 is vertical in its position of use. When the lower guide 16 comprises a rail 60 or an auxiliary rail 54 which the claw 68 grips and the claw 68 is pulled down, the claw 68 extends lower than the rail 60 or auxiliary rail 54 in the vertical direction. The claw 68 is fitted in the panel 10 or lath 20 in such a way that it tends to pull upwards towards the panel 10 or lath 12 and away from the lower guide 16. According to an example, to the claw 68 is connected a spring which is located in the panel 10 or lath 20, and by the force of which the claw 68 is continuously pulled upwards.

According to an example, the claw 68 comprises a structure which extends downwards from the panel 10 or lath 20 and rotates past the flange 64 and under the flange 64 and is able to settle, for example, against the lower surface of the flange 64. The claw 68 is then pulled down and the end of the claw 68 is against the lower surface of the flange 64. As the panel 10 moves, the end of the claw 68 is able to move along the lower surface of the upper guide 64. At the end of the claw 68 may be an inclined, wedge-like shape or guiding surface.

According to an example, the claw 68 is located on the same side of the rail 60 or auxiliary rail 54 as the tapered section 56. According to an example, the claw 68 is located on the same side of the rail 60 or auxiliary rail 54 as the support part 48 or support surface 52. Thus, when the claw 68 is pulled up, the claw 68 may extend lower than the upper surface of the rail 60 or auxiliary rail 54 in the vertical direction.

The claw 68 is at a distance from the hinge element 42. The claw 68 may be a part of the control element 46. The claw 68 is located in the panel 10 or lath 20 at a point which settles in front of the flange 64 ending in the tapered section 56 or in front of the guide surface 58 when the panel 10 closes. The said point is, for example, at the support surface 52 of the support part 48 or at the auxiliary rail 54.

According to an example, the claw 68 is forced to move downwards and guided to grip the lower guide 16, the rail 60 or the auxiliary rail 54 by utilising one or more of the guide surfaces 58 described above. In addition to this, the guide surface 58 allows the claw 68 to move upwards and to detach from the lower guide 16, the rail 60 or the auxiliary rail 54. The claw 68 or the end of the claw 68 is then able to move through the tapered section 56.

The guide surface 58 is fitted to a predetermined point and height, where the guide surface 58 may settle into contact with a moving, retracted claw 68, for example, with the end of the claw 68. The claw 68 then moves with a panel 10 which is closed and moves in a first direction, in which direction the guide surface 58 also descends. The claw 68 slides along the guide surface 58 which, due to wedge-like activity, forces the claw 68 downwards and guides the claw 68 under the flange 64 in the lower guide 16, the rail 60 or the auxiliary rail 54. When the panel 10 moves or is stationary and closed, the claw 68 remains under the flange 64 and prevents the panel 10 from rising. When the panel 10 moves in the opposite second direction, the same guide surface 58 allows the claw 68 to retract upwards by itself and to detach from the lower guide 16, the rail 60 or the auxiliary rail 54.

According to an example, the end of the claw 68 slides along the guide surface 58 and the lower surface of the flange 64.

According to an example, the panel 10 or the lath 20 comprises two of the claws 68 described above, which are located on opposite sides of the lower guide 16 structure, the rail 60 or the auxiliary rail 54. One of the claws 68 is located on opposite side of the lower guide 16, the rail 60 or the auxiliary rail 54 with respect to the support part 48 or support surface 52. Thus, when the claw 68 is retracted upwards, the claw 68 extends downwards in the vertical direction, to the level of or higher than the lower guide 16 structure, the rail 60 or the auxiliary rail 54. The said claw 68 is thus able to move over the lower guide 16 structure, the rail 60 or the auxiliary rail 54 with the opening panel 10, and the claw 68 will not prevent the opening of the panel by settling against the lower guide 16 structure, the rail 60 or the auxiliary rail 54. When the said claw 68 is retracted upwards, the claw 68 may extend lower than the upper surface of the lower guide 16 structure, the rail 60 or the auxiliary rail 54 in the vertical direction.

According to a first example, the two claws 68 described above, which are located on opposite sides of the lower guide 16 structure, the rail 60 or the auxiliary rail 54, are connected to each other and move together and simultaneously. According to another example, the claws 68 are connected to each other in such a way that when one of the claws 68 moves downwards, it forces also the other claw 68 to move at least downwards. In the above-mentioned first and second examples, one of the claws 68 is forced to a height, where, when the panel 10 moves, the said claw 68 may settle against the guide surface 58 or under or below the flange 64 in the rail 60 or auxiliary rail 54, as described above.

The upper guide 14 and/or the lower guide 16 or the lath 18 and/or lath 20 are, according to one example, made of aluminium or an aluminium alloy, and have a continuous or elongated in shape. It is also possible to use other materials and metals.

The hinge element 32, 34, 40, 42 or the control element 36, 38, 44, 46 or support part 48 or auxiliary rail 54 or support 66 or claw 68 is most preferably a piece made of plastic material but other materials, such as metal, may also be used.

According to one example, the panel 10, 12 is made of tempered glass. It is also possible to use other glass materials and sheet-like materials. The panel 10, 12 is preferably transparent, but opaque panels can also be used.

The solution presented is not limited only to the alternatives and examples shown in the accompanying Figures or specifically disclosed in the foregoing description, or to which reference has been made in the description. The features disclosed in the foregoing may be combined and implemented in various combinations.

The different embodiments of the solution are disclosed in the accompanying claims.

1. A panel system, wherein the panel system comprises:
a panel which is movable and vertical; and
a lower guide and an upper guide which are essentially parallel and between which the panel is positioned and to which the panel is connected for moving;
wherein the lower guide on which the panel rests when moving along the lower guide, and on at least one side of the rail is a flange which is fixed to an essentially vertical web of the rail, extends sideways from the web and has a lower surface which is directed downwards;
wherein the panel comprises a claw which is configured to grip the lower guide to prevent the panel from rising or lifting off from the rail;
wherein the claw is connected to the panel in such a way that the claw is able to move vertically when the panel is vertical, wherein the claw is fitted in the panel such a way that the claw tends to retract upwards away from the lower guide towards the panel by itself and grips the lower guide when pulled down away from the panel; and
wherein the claw is configured to remain under the flange and to move along the lower surface of the flange while the panel is moving and the claw is being pulled down away from the panel.

2. The panel system according to claim 1, wherein the claw comprises a structure which extends downwards from the panel past the flange under the flange and settles against the lower surface of the flange.

3. The panel system according to claim 2, wherein the claw comprises an end which settles against the lower surface of the flange.

4. The panel system according to claim 1, wherein the flange extends in a longitudinal direction of the rail and extends sidewards from the web.

5. The panel system according to claim 1, wherein the flange comprises a tapered section which is narrower than a section of said flange that is preceding either the beginning or the end of the tapered section, or both.

6. The panel system according to claim 1, wherein the rail comprises a guide surface as an extension of the flange, which guide surface is directed downwards and inclined with respect to a horizontal direction and the flange.

7. The panel system according to claim 6, wherein when the panel moves in a first direction, the guide surface that is fitted to a predetermined point and height is adapted to settle into contact with the claw that is moving with the panel; and wherein the guide surface is configured to force the claw that is moving along the guide surface to move down away from the panel and to guide the claw under the flange.

8. The panel system according to claim 7, wherein when the panel moves in a second direction that is opposite to the first direction, the guide surface is configured to allow the claw to move upwards towards the panel and away from under the flange for detaching from the lower guide.

9. The panel system according to claim 1, wherein the claw extends vertically lower than an upper surface of the rail both when the claw is pulled out and when the claw is retracted.

10. The panel system according to claim 1, wherein the rail has an auxiliary rail as an extension of the rail on which auxiliary rail the panel is adapted to rest when the panel moves.

11. The panel system according to claim 5, wherein the rail has an auxiliary rail as an extension of the rail on which auxiliary rail the panel is adapted to rest when the panel moves and in which auxiliary rail the tapered section is located.

12. The panel system according to claim 6, wherein the rail has an auxiliary rail as an extension of the rail on which auxiliary rail the panel is adapted to rest when the panel moves and in which auxiliary rail the guide surface is located.

13. The panel system according to claim 10, wherein a support part is fixed adjacent to the lower guide, which support part is adapted to support the panel that is opening and which panel has been moved to a predetermined point for opening the panel; and
wherein the support part and the auxiliary rail are fixed to one another or the auxiliary rail is a seamless part of the support part.

14. The panel system according to claim 13, a support is fixed to the panel by means of which support the panel that is opening or closing is supported on the support part and which support slides along the support part when the panel opens or closes.

15. The panel system according to claim 1, wherein the claw is a first claw and the panel comprises a second claw on opposite side of the lower guide with respect to the first claw which second claw is configured to grip the lower guide, and
wherein the second claw is connected to the panel in such a way that the second claw is able to move vertically when the panel is vertical, wherein the second claw is fitted in the panel such a way that the second claw tends to retract upwards away from the lower guide towards the panel by itself and grips the lower guide when pulled down away from the panel, and
wherein the first claw is configured to force the second claw to move down away from the panel when the first claw is moving down away from the panel.

16. A panel suitable for use in a panel system, the panel being movable and intended to be located and connected between a lower guide and a upper guide of the panel system for moving the panel on the lower guide, wherein the lower guide and the upper guide are essentially parallel;
wherein the panel further comprises a claw which is configured to grip the lower guide, and
wherein the claw is connected to the panel in such a way that the claw is able to move vertically when the panel is vertical, wherein the claw is fitted in the panel such a way that it tends to retract upwards away from the lower guide towards the panel by itself and grips the lower guide when pulled down away from the panel.

17. The panel according to claim 16, wherein the claw is a first claw and the panel comprises a second claw on opposite side of the lower guide with respect to the first claw which second claw is configured to grip the lower guide, and
wherein the second claw is connected to the panel in such a way that the second claw is able to move vertically when the panel is vertical, wherein the second claw is fitted in the panel such a way that the second claw tends to retract upwards away from the lower guide towards the panel by itself and grips the lower guide when pulled down away from the panel, and
wherein the first claw is configured to force the second claw to move down away from the panel when the first claw is moving down away from the panel.

18. The panel according to claim 16, wherein a lath is fixed on a lower edge of the panel to which lath the claw is movably connected and by means of which lath the claw is fixed to the panel.

19. A lower guide of a panel system, on which lower guide a panel of the panel system is intended to rest when the panel is moving along the lower guide,
wherein the lower guide comprises a rail on which the panel may rest when moving along the lower guide, and
wherein the lower guide comprises an auxiliary rail as an extension of the rail, on which auxiliary rail the panel may also rest when the panel is moving along the lower guide.

20. The lower guide according to claim 19,
wherein on at least one side of the rail is a flange (64) which is fixed to an essentially vertical web of the flange extends in a longitudinal direction of the rail and extends sidewards from the web and which flange has a downwards directed lower surface;
wherein the flange has a guide surface as an extension of the flange, which guide surface is directed downwards and is inclined with respect to a horizontal direction and the flange;
wherein the flange comprises a tapered section which is narrower than a section of the said flange that is preceding either the beginning or the end of the tapered section, or both; and
wherein the tapered section is located in the auxiliary rail.

21. The lower guide according to claim 20, wherein a support part is fixed adjacent to the lower guide, which support part supports the panel that is opening and has been moved to a predetermined point for opening the panel, and
wherein the support part and the auxiliary rail are fixed to one another or the auxiliary rail is a seamless part of the support part.
